(19) United States
(12) Patent Application Publication
(10) Pub. No.: US 2015/0363184 A1
(43) Pub. Date: Dec. 17, 2015

(54) METHODS AND DEVICES FOR PROMPTING APPLICATION REMOVAL

(71) Applicant: Xiaomi Inc., Beijing (CN)

(72) Inventors: Bin Wang, Beijing (CN); Dongfang Ji, Beijing (CN); Zhiguang Zheng, Beijing (CN)

(73) Assignee: Xiaomi Inc.

(21) Appl. No.: 14/617,101

(22) Filed: Feb. 9, 2015

Related U.S. Application Data
(63) Continuation of application No. PCT/CN2014/091742, filed on Nov. 20, 2014.

(30) Foreign Application Priority Data
Jun. 12, 2014 (CN) 201410262155.2

(51) Int. Cl. G06F 9/445; G06F 17/30

(52) U.S. Cl. CPC G06F 8/62; G06F 17/3053

(57) ABSTRACT

A method for a device to prompt application removal is provided. The method includes: receiving an instruction for removing an application; acquiring historical use information of the application based on the instruction for removing application; and outputting removal prompting information based on the historical use information.

### CROSS-REFERENCE TO RELATED APPLICATIONS

This application is a continuation of International Application No. PCT/CN2014/091742, filed Nov. 20, 2014, which is based upon and claims priority to Chinese Patent Application No. 201410262155.2, filed Jun. 12, 2014, the entire contents of all of which are incorporated herein by reference.

### TECHNICAL FIELD

The present disclosure generally relates to the field of mobile communication and, more particularly, to methods and devices for prompting application removal.

### BACKGROUND

Applications may be installed on or removed from a terminal device according to user input. When removing an application, local data associated with an application on the device terminal will be removed along with the application. Conventionally, when the user initiates removal of an application, a prompting window will be popped up for the user to confirm that the application is to be removed.

### SUMMARY

According to a first aspect of the present disclosure, there is provided a method for a device to prompt application removal, comprising: receiving an instruction for removing an application; acquiring historical use information of the application based on the instruction for removing application; and outputting removal prompting information based on the historical use information.

According to a second aspect of the present disclosure, there is provided a device, comprising: a processor; and a memory for storing instructions executable by the processor. The processor is configured to: receive an instruction for removing an application; acquire historical use information of the application based on the instruction for removing application; and output removal prompting information based on the historical use information.

According to a third aspect of the present disclosure, there is provided a non-transitory computer-readable storage medium having stored therein instructions that, when executed by a processor in a device, cause the device to perform operations including: receiving an instruction for removing an application; acquiring historical use information of the application based on the instruction for removing application; and outputting removal prompting information based on the historical use information.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for prompting application removal, according to an exemplary embodiment.

FIG. 2 is a flowchart of a method for prompting application removal, according to an exemplary embodiment.

FIG. 3 is a diagram showing an interface for outputting removal prompting information, according to an exemplary embodiment.

FIG. 4 is a diagram showing an interface for outputting removal prompting information, according to an exemplary embodiment.

FIG. 5 is a flowchart of a method for prompting application removal, according to an exemplary embodiment.

FIG. 6 is a diagram showing an interface for outputting removal prompting information, according to an exemplary embodiment.

FIG. 7 is a flowchart of a method for prompting application removal, according to an exemplary embodiment.

FIG. 8 is a diagram showing an interface for outputting removal prompting information, according to an exemplary embodiment.

FIG. 9 is a flowchart of a method for prompting application removal, according to an exemplary embodiment.

FIG. 10 is a diagram showing an interface for outputting removal prompting information, according to an exemplary embodiment.

FIG. 11 is a flowchart of a method for prompting application removal, according to an exemplary embodiment.

FIG. 12 is a block diagram of a device for prompting application removal, according to an exemplary embodiment.

FIG. 13 is a block diagram of an output module, according to an exemplary embodiment.

FIG. 14 is a block diagram of an output module, according to an exemplary embodiment.

FIG. 15 is a block diagram of an output module, according to an exemplary embodiment.

FIG. 16 is a block diagram of an output module, according to an exemplary embodiment.

FIG. 17 is a block diagram of a device for prompting application removal, according to an exemplary embodiment.

FIG. 18 is a block diagram of a terminal device for prompting application removal, according to an exemplary embodiment.

### DETAILED DESCRIPTION

Reference will now be made in detail to exemplary embodiments, examples of which are illustrated in the accompanying drawings. When accompanying drawings are mentioned in the following description, the same numbers in different drawings represent the same or similar elements unless otherwise represented. The following exemplary embodiments and description thereof intend to illustrate, rather than to limit, the present disclosure. Hereinafter, the present disclosure will be described with reference to the drawings.

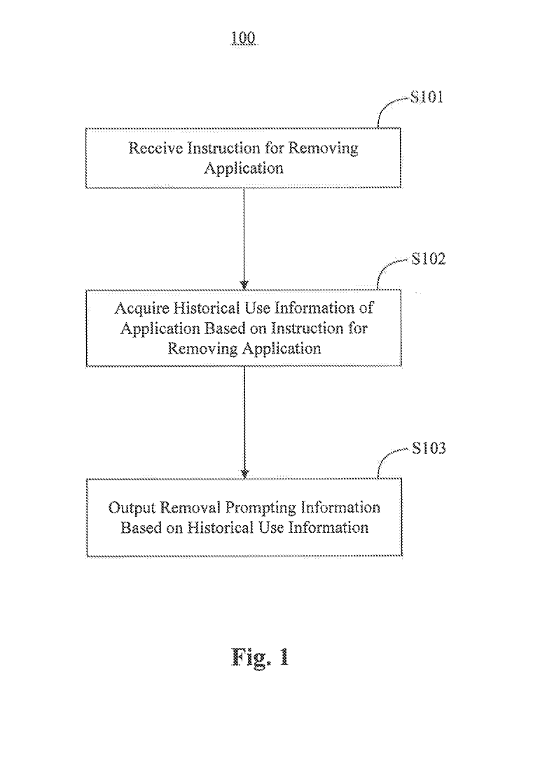

FIG. 1 is a flowchart of a method 100 for prompting application removal, according to an exemplary embodiment. For example, the method 100 may be used in a terminal device. Referring to FIG. 1, the method 100 includes the following steps.

In step 101, the terminal device receives an instruction for removing an application. For example, the instruction for removing an application may be received from a removal operation performed by a user with respect to an application in the terminal device.

In step 102, the terminal device acquires historical use information of the application based on the instruction for removing application. For example, the historical use information may include the user's operation history with respect to the application, which may reflect whether the user uses the application frequently, and an importance level of the application for the user. Through acquiring the historical use information of the application, the terminal device may determine whether the user is removing an application that is frequently used or has a high importance level.

In step 103, the terminal device outputs removal prompting information based on the historical use information.

In some embodiments, the terminal device may determine whether the user frequently uses the application to be removed, or the importance level of the application for the user based on the acquired historical use information. Different removal prompting information may be outputted based on the historical use information of the application to be removed.

For example, when the user initiates removal of an application that is used infrequently, the terminal device may output regular removal prompting information, e.g. “sure to remove the application?” As another example, when the user initiates removal of an application that is used frequently, the terminal device may output a special prompt that an important application is being removed so as to alert the user that an application which has a high importance level or is frequently used is being removed.

In some embodiments, the historical use information may include a use parameter associated with the use history of the application, and/or a volume of data stored locally by the application. The use parameter may include a use frequency, a number of use, a duration of use, and/or a combination thereof. The terminal device may then determine the importance level of the application based on part or all of the historical use information.

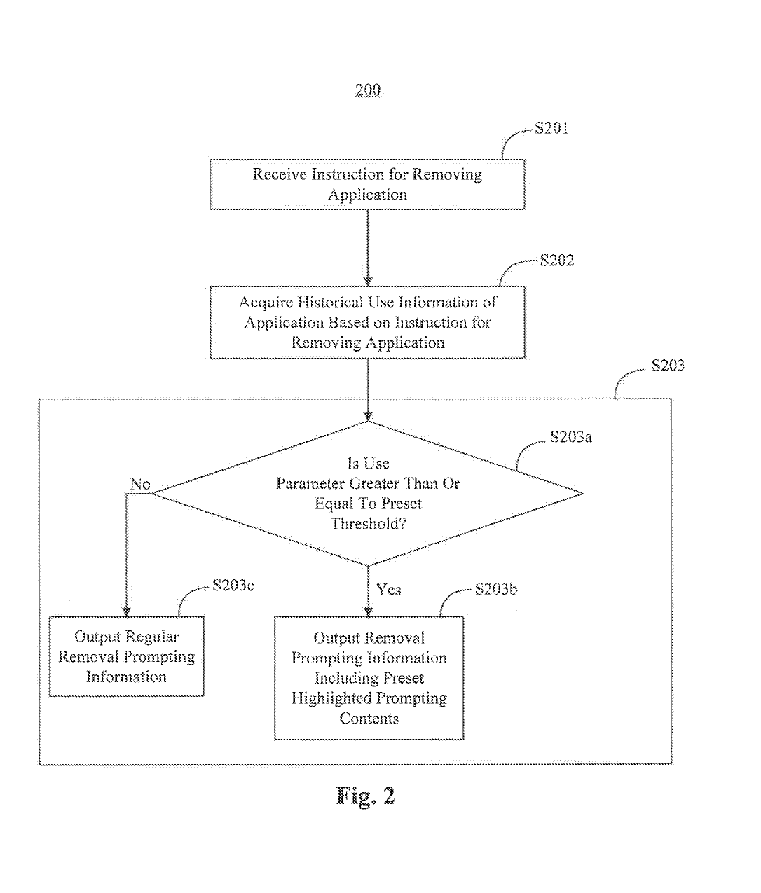

FIG. 2 is a flowchart of a method 200 for prompting application removal, according to an exemplary embodiment. In the illustrated embodiment, the historical use information includes a use parameter of the application. Referring to FIG. 2, the method 200 includes the following steps.

In step 201, the terminal device receives an instruction for removing an application.

In step 202, the terminal device acquires historical use information of the application based on the instruction for removing application.

The historical use information includes a use parameter of the application. For example, the use parameter may include a use frequency, a number of use, a duration of use, and/or a combination thereof.

In step 203, the terminal device outputs removal prompting information based on the historical use information. Step 203 includes the following steps.

In step 203a, the terminal device determines whether the use parameter is greater than or equal to a preset threshold. If the use parameter is greater than or equal to the corresponding preset threshold, step 203b is performed. If the use parameter is less than to the preset threshold, step 203c is performed.

For different use parameters, such as the use frequency, the number of use, the duration of use, different preset thresholds may be used for determining the importance level of the application or whether the user uses the application frequently.

For example, a threshold of once per day may be preset for the use frequency in the use parameters, and correspondingly the terminal device may determine whether the use frequency of the application is greater than or equal to the threshold of once per day. As another example, a threshold of 50 times may be preset for the number of use, and correspondingly the terminal device may determine whether the number of use of the application exceeds the threshold of 50 times. As another example, a threshold of 30 hours may be preset for the duration of use, and correspondingly the terminal device may determine whether the accumulated duration of use by the application exceeds the threshold of 30 hours.

In step 203b, if the use parameter is greater than or equal to the corresponding preset threshold, the terminal device outputs removal prompting information including preset highlighted prompting contents.

In step 203c, if the use parameter is less than the corresponding preset threshold, the terminal device outputs regular removal prompting information.

If the use parameter is greater than or equal to the corresponding preset threshold, it is determined that the importance level of the application for the user is high or the application is frequently used by the user. Then the terminal device outputs the removal prompting information including preset highlighted prompting contents. If the use parameter is less than the corresponding preset threshold, it is determined that the importance level of the application for the user is low or the application is infrequently used by the user. Then the terminal equipment outputs the regular removal prompting information.

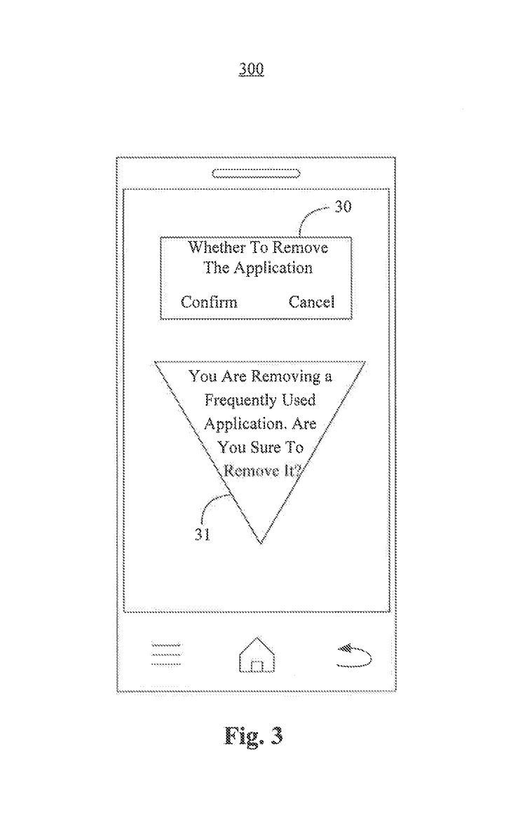

FIG. 3 is a diagram showing an interface 300 for outputting removal prompting information, according to an exemplary embodiment. As shown in FIG. 3, in addition to prompting information 30 for confirming whether to continue this removal operation by the user, the removal prompting information further includes preset highlighted prompting contents 31. The preset highlighted prompting contents 31 are used to alert the user that an application that has a high importance level or is frequently used is being removed. For example, the preset highlighted prompting contents 31 shown in FIG. 3 are “You are removing a frequently used application. Are you sure to remove it?” By contrast, the regular removal prompting information includes the prompting information 30 for confirming whether to continue this removal operation by the user, but does not include the preset highlighted prompting contents 31.

By outputting the preset prompting contents to alert the user that this removal operation will remove an application that has a high importance level or is frequently used, the chance of accidental removal of the application may be reduced, and user data loss resulting from accidental removal of the application may be prevented.

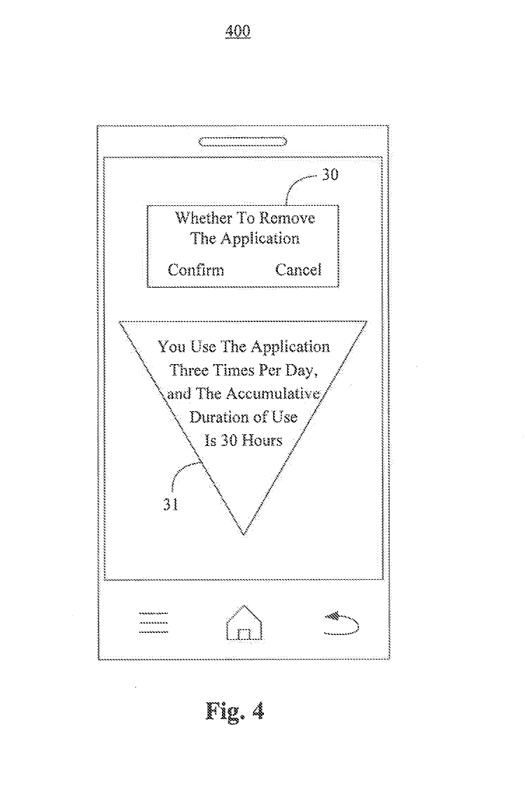

FIG. 4 is a diagram showing an interface 400 for outputting removal prompting information, according to an exemplary embodiment. In some embodiments, the preset prompting contents 31 in the removal prompting information may include the acquired use parameter. For example, as shown in FIG. 4, the preset prompting contents 31 may include a use frequency and duration of use of the application, alerting the user the importance level of the application to be removed.

In some embodiments, an application to be removed that has a high importance level may also be prompted to the user through a manner of voice prompting. The contents of voice prompting may be associated with the preset prompting contents. For example, the voice prompting may alert the user that an application that has a high importance level or is frequently used is being removed. As another example, the voice prompting may provide the use parameters of the application to be removed by voice output, thereby further reducing the chance of accidental removal operations by the user.

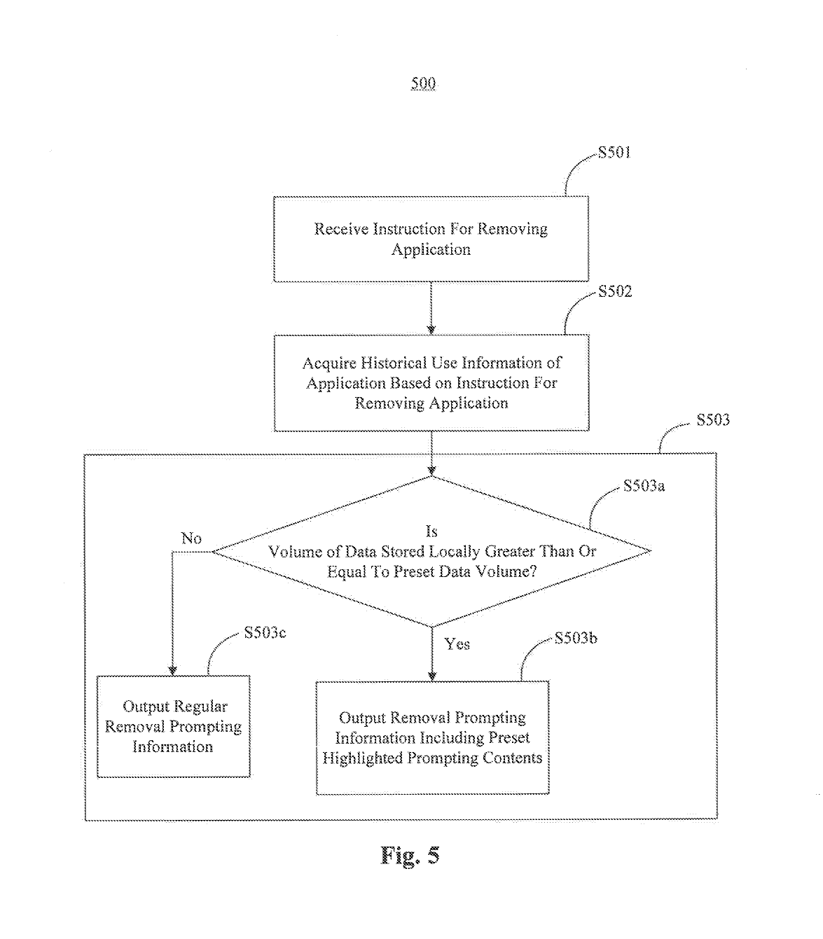

FIG. 5 is a flowchart of a method 500 for prompting application removal, according to an exemplary embodiment. In the illustrated embodiment, the historical use information includes a volume of data stored locally by the application. Referring to FIG. 5, the method 500 includes the following steps.

In step 501, the terminal device receives an instruction for removing an application.

In step 502, the terminal device acquires historical use information of the application based on the instruction for removing application.

The historical use information includes the volume of data stored locally by the application. Through the volume of data stored locally, the terminal device determines whether the application has a high importance level or is frequently used.

In step 503, the terminal device outputs corresponding removal prompting information based on the historical use information. Step 503 further includes the following steps.

In step 503a, the terminal device determines whether the volume of data stored locally by the application is greater than or equal to a preset data volume. If the volume of data stored locally by the application is greater than or equal to the preset data volume, step 503b is performed. If the volume of data stored locally by the application is less than the preset data volume, step 503c is performed.

If the application is frequently used, the user data stored locally will be of a relatively high volume. The terminal device determines whether the application to be removed has a high importance level or is frequently used based on the volume of the data stored locally by the application. For example, the terminal device may determine whether the volume of data stored locally by the application to be removed is greater than or equal to a preset data volume of 50 M.

In step 503b, if the volume of data stored locally by the application is greater than or equal to the preset data volume, the terminal device outputs removal prompting information including preset highlighted prompting contents.

In step 503c, if the volume of data stored locally by the application is less than the preset data volume, the terminal device outputs regular removal prompting information.

As described above in connection with FIG. 3, the removal prompting information including preset highlighted prompting contents includes the prompting information 30 for confirming whether to continue this removal operation by the user and the preset highlighted prompting contents 31. The regular removal prompting information includes the prompting information 30 for confirming whether to continue this removal operation by the user, but does not include the preset highlighted prompting contents 31.

If the volume of data stored locally by the application to be removed is greater than or equal to the preset data volume, it is determined that the application to be removed has a high importance level or is frequently used by the user. Correspondingly, removal prompting information including the preset prompting contents 31 as shown in FIG. 3 is outputted to prompt the user to verify whether the application to be removed is correct, thereby reducing the chance of accidental removal operations. If the volume of data stored locally by the application to be removed is less than the preset data volume, it is determined that the importance level of the application to be removed for the user is low or the application is infrequently used by the user. Correspondingly, regular removal prompting information is outputted.

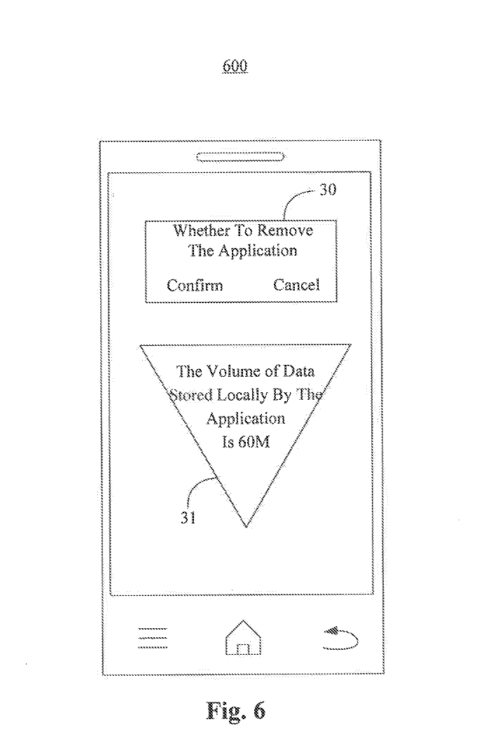

FIG. 6 is a diagram showing an interface 600 for outputting removal prompting information, according to an exemplary embodiment. In some embodiments, preset prompting contents in the removal prompting information may further include the volume of data stored locally by the application. For example, as shown in FIG. 6, the preset prompting contents 31 displays that the volume of data stored locally by the application is 60 M, alerting the user that the application to be removed has a high importance level.

In some embodiments, the application that has a high importance level is being removed can be prompted to the user not only through the manner of displaying text, but also through a manner of voice prompting. The contents of the voice prompting may be associated with the preset prompting contents. For example, the voice prompting may alert the user that an application that has a high importance level or is frequently used is being removed. As another example, the voice prompting may provide the volume of data stored locally by the application by voice output, thereby further reducing the chance of accidental removal operations by the user.

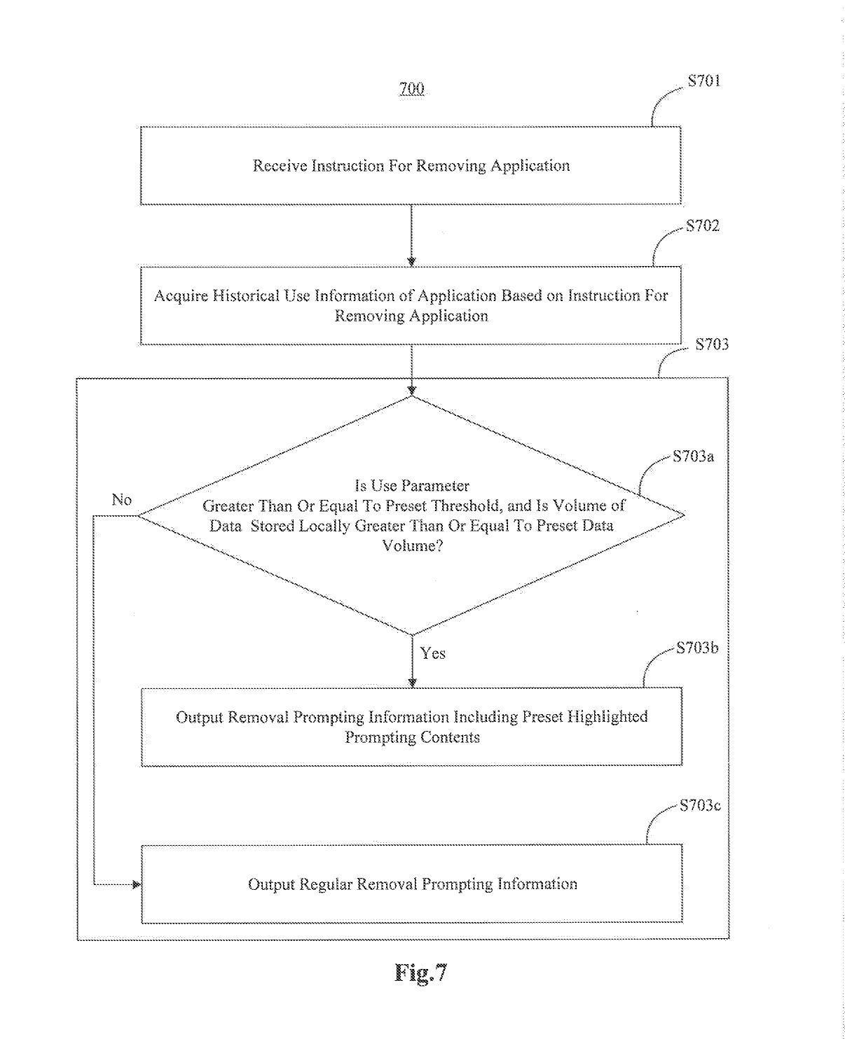

FIG. 7 is a flowchart of a method 700 for prompting application removal, according to an exemplary embodiment. In the illustrated embodiment, the historical use information includes the use parameter of the application and the volume of data stored locally by the application. Referring to FIG. 7, the method 700 includes the following steps.

In step 701, the terminal device receives an instruction for removing an application.

In step 702, the terminal device acquires historical use information of the application based on the instruction for removing application.

The historical use information includes the use parameter of the application and the volume of data stored locally by the application. The use parameter may include a use frequency, a number of use, a duration of use, and/or a combination thereof.

In step 703, the terminal device outputs removal prompting information based on the historical use information. Step 703 further includes the following steps.

In step 703a, the terminal device determines whether the use parameter is greater than or equal to a corresponding preset threshold, and whether the volume of data stored locally by the application is greater than or equal to a preset data volume. If the use parameter is greater than or equal to the corresponding preset threshold, and the volume of data stored locally by the application is greater than or equal to the preset data volume, step 703b is performed. If the use parameter is less than the corresponding preset threshold, or the volume of data stored locally by the application is less than the preset data volume, step 703c is performed.

The terminal device determines whether the application to be removed is frequently used by the user or has a high importance level based on both the use parameter and the volume of data stored locally.

In step 703b, if the use parameter is greater than or equal to the corresponding preset threshold, and the volume of data stored locally by the application is greater than or equal to the preset data volume, the terminal device outputs removal prompting information including preset highlighted prompting contents. If the use parameter of the application to be removed is greater than or equal to the corresponding preset threshold and the volume of data stored locally by the application is greater than or equal to the preset data volume, it is determined that the application to be removed has a high importance level or is frequently used. Correspondingly, removal prompting information including, e.g., the preset prompting contents 31 (FIG. 3), is outputted to alert the user that a frequently used application is being removed, thereby reducing the chance of accidental removal operations.

In step 703c, if the use parameter is less than the corresponding preset threshold, or the volume of data stored locally by the application is less than the preset data volume, the terminal device outputs regular removal prompting information.

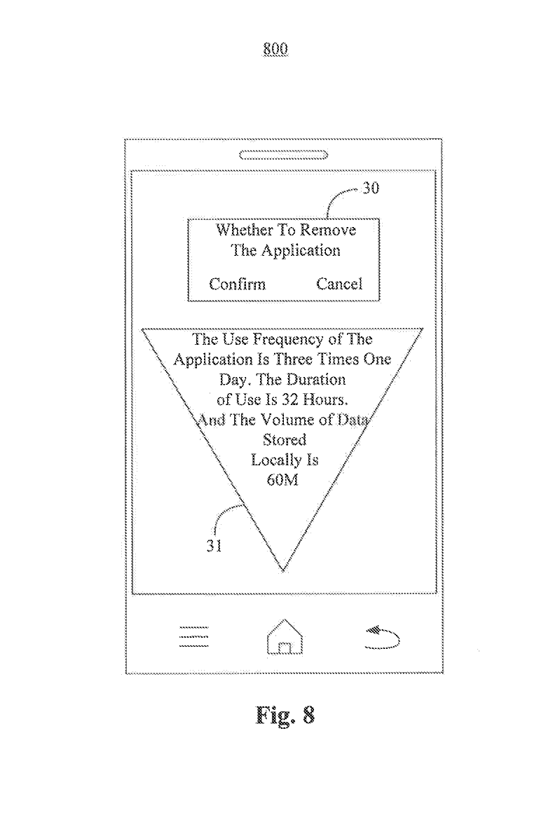

FIG. 8 is a diagram showing an interface 800 for outputting removal prompting information, according to an exemplary embodiment. In some embodiments, preset prompting contents in the removal prompting information may further include the use parameter of the application and the volume of data stored locally by the application. For example, as shown in FIG. 8, the preset prompting contents 31 displays that the use frequency of the application is “three times/day,” the duration of use is “32 hours,” and the data volume stored locally is 60 M, alerting the user that the application to be removed has a high importance level and prompting the user to verify whether to remove the application.

In some embodiments, it may also be prompted to the user that an application having a high importance level is being removed by voice prompting. The contents of the voice prompting may be associated with the preset prompting contents. For example, the voice prompting may alert the user that an application having a high importance level or being frequently used is being removed. As another example, the voice prompting may provide the use parameters and the volume of data stored locally by the application by voice output, thereby reducing the chance of accidental removal operations by the user.

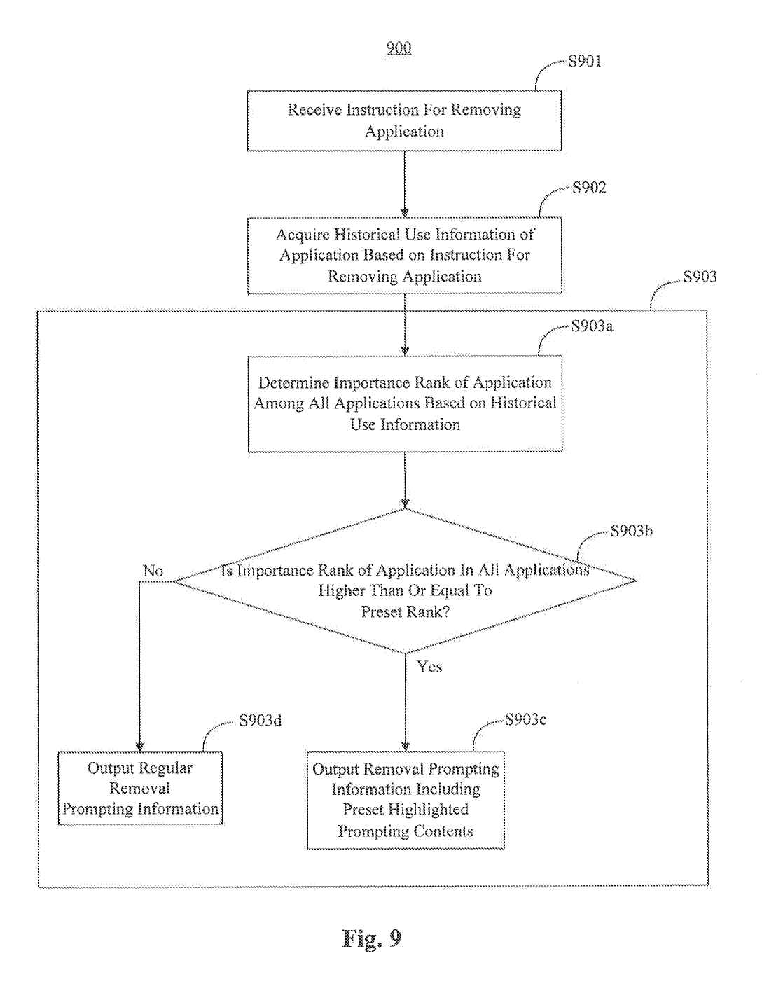

FIG. 9 is a flowchart of a method 900 for prompting application removal, according to an exemplary embodiment. In the method 900, the historical use information includes the use parameter of the application and the volume of data stored locally by the application. Referring to FIG. 9, the method 900 includes the following steps.

In step 901, the terminal device receives an instruction for removing application.

In step 902, the terminal device acquires historical use information of the application based on the instruction for removing application.

In step 903, the terminal device outputs removal prompting information based on the historical use information. Step 903 further includes the following steps.

In step 903a, the terminal device determines an importance rank of the application among, e.g., all applications installed on the terminal, based on the historical use information.

For example, the importance rank may be determined based on the use parameter in the historical use information and the volume of data stored locally. Also for example, the application having a higher use frequency, a longer duration of use and a higher number of use may be determined to have a higher rank. The application having more data stored locally may also be determined to have a higher rank. The importance rank of each application in all applications may be obtained through a weighted calculation between the rank of each use parameter and the rank of the volume of data stored locally.

In step 903b, the terminal device determines whether the importance rank of the application among all applications is higher than or equal to a preset rank. If the importance rank of the application in all applications is higher than or equal to the preset rank, step 903c is performed. If the importance rank of the application in all applications is lower than the preset rank, step 903d is performed.

In step 903c, if the importance rank of the application among all applications is higher than or equal to the preset rank, the terminal device outputs removal prompting information including preset highlighted prompting contents.

In step 903d, if the importance rank of the application among all applications is lower than the preset rank, the terminal device outputs regular removal prompting information.

If the importance rank of the application to be removed among all applications is higher than or equal to the preset rank, it is determined that the application to be removed is frequently used by the user or has a high importance level. Correspondingly, removal prompting information including, e.g., the preset prompting contents 31 as shown in FIG. 3, may be outputted to alert the user that a frequently used application is being removed, thereby reducing the chance of accidental removal operations.

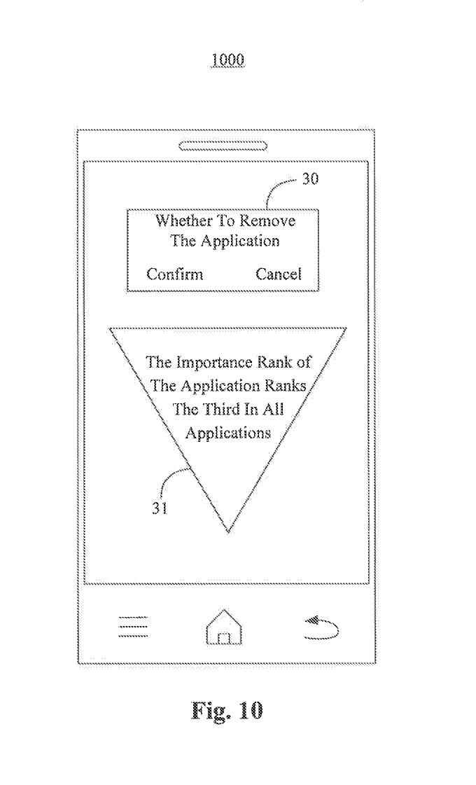

FIG. 10 is a diagram showing an interface 1000 for outputting removal prompting information, according to an exemplary embodiment. In some embodiments, preset prompting contents in the removal prompting information may include the importance rank of the application among all applications. For example, as shown in FIG. 10, the preset prompting contents 31 display that the importance rank of the application “ranks the third in all applications,” alerting the user that the application to be removed has a high importance and prompting the user to further verify whether to remove the application.

In some embodiments, the terminal device may alert the user that an application which has a high importance level is being removed by voice prompting. The contents of the voice prompting may be associated with the preset prompting contents. For example, the voice prompting may alert the user that an application which has a high significance or is frequently used is being removed. As another example, the voice prompting may provide the importance rank of the application to be removed in all applications through voices, thereby reducing the chance of accidental removal operations by the user.

In some embodiments, the terminal device may output the removal prompting information including preset highlighted prompting contents multiple times, e.g., twice or more times, so as to enhance the prompting effect. The number of times the removal prompting information is outputted may be varying based on the importance level of the application to be removed. For example, the removal prompting information may be outputted for more times if the importance level of the application is higher.

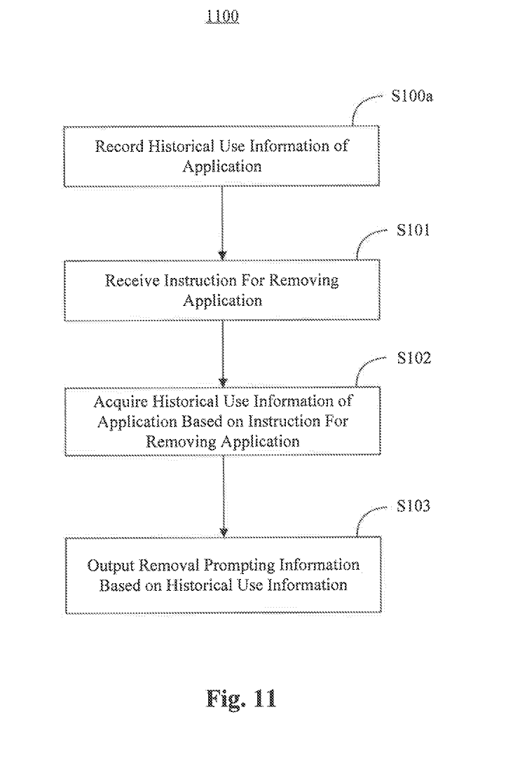

FIG. 11 is a flowchart of a method 1100 for prompting application removal, according to an exemplary embodiment. Referring to FIG. 11, the method 1100 includes step S100a before steps S101, S102, and S103 of the method 100 (FIG. 1).

In step 100a, the terminal device records the historical use information of the application.

The terminal device may record historical use information of all applications installed in a system, and the recorded historical use information may include the use parameter associated with each of the applications and the volume of data stored locally by each of the applications. For example, the use parameter may include a use frequency, a number of use, duration of use, and/or a combination thereof.

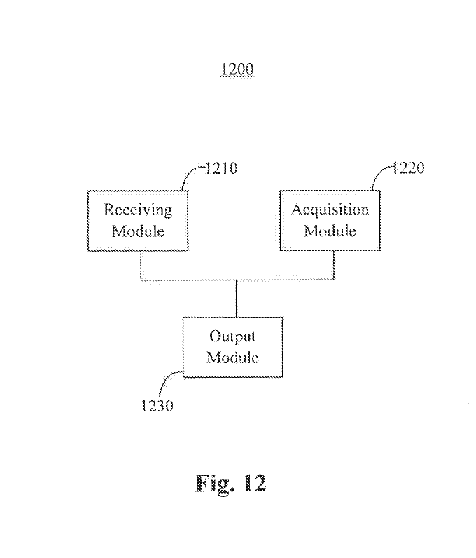

FIG. 12 is a block diagram of a device 1200 for prompting application removal, according to an exemplary embodiment. Referring to FIG. 12, the device 1200 includes a receiving module 1210, an acquisition module 1220, and an output module 1230.

The receiving module 1210 is configured to receive an instruction for removing an application.

The acquisition module 1220 is configured to acquire historical use information of the application based on the instruction for removing application received by the receiving module 1210.

The output module 1230 is configured to output corresponding removal prompting information based on the historical use information acquired by the acquisition module 1220.

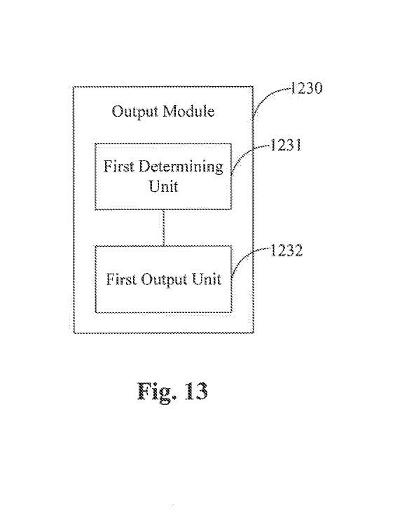

FIG. 13 is a block diagram of the output module 1230 (FIG. 12), according to an exemplary embodiment. As shown in FIG. 13, the output module 1230 includes a first determining unit 1231 and a first output unit 1232.

The first determining unit 1231 is configured to determine whether the use parameter is greater than or equal to a corresponding preset threshold.

The first output unit 1232 is configured to output removal prompting information including preset highlighted prompting contents when the first determining unit 1231 determines that the use parameter is greater than or equal to the corresponding preset threshold.

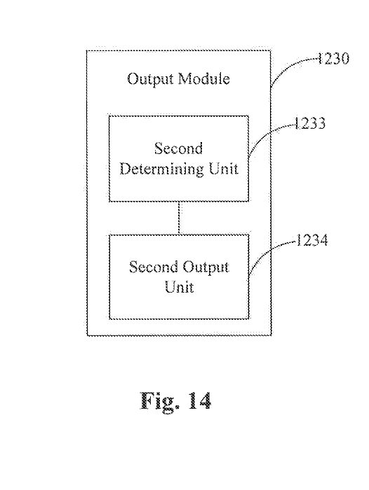

FIG. 14 is a block diagram of the output module 1230 (FIG. 12), according to an exemplary embodiment. As shown in FIG. 14, the output module 1230 includes a second determining unit 1233 and a second output unit 1234.

The second determining unit 1233 is configured to determine whether a volume of data stored locally by the application is greater than or equal to a preset data volume.

The second output unit 1234 is configured to output removal prompting information including preset highlighted prompting contents when the second determining unit 1233 determines that the volume of data stored locally by the application is greater than or equal to the preset data volume.

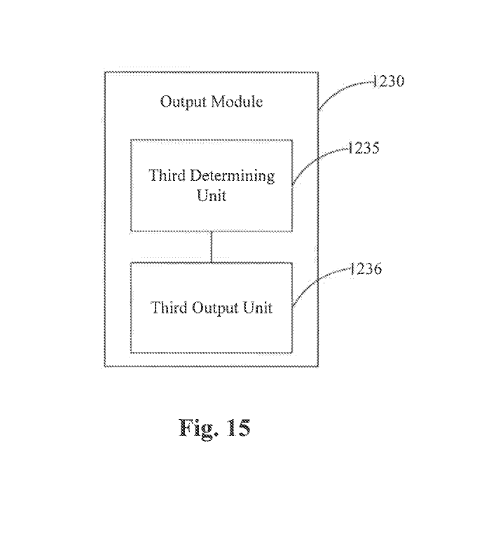

FIG. 15 is a block diagram of the output module (FIG. 12), according to an exemplary embodiment. As shown in FIG. 15, the output module 1230 includes a third determining unit 1235 and a third output unit 1236.

The third determining unit 1235 is configured to determine whether the use parameter is greater than or equal to the corresponding preset threshold, and whether the volume of data stored locally by the application is greater than or equal to the preset data volume.

The third output unit 1236 is configured to output removal prompting information including preset highlighted prompting contents when the third determining unit 1235 determines that the use parameter is greater than or equal to the corresponding preset threshold, and the volume of data stored locally by the application is greater than or equal to the preset data volume.

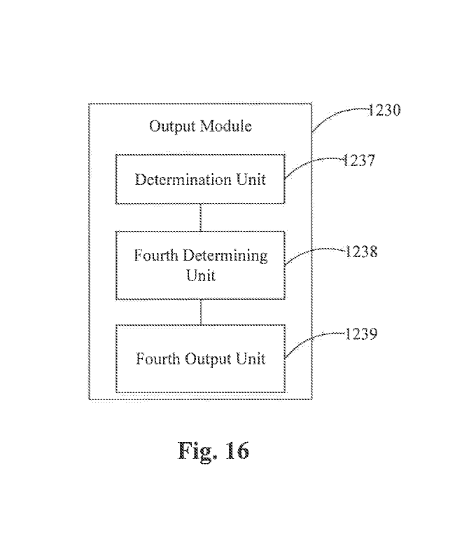

FIG. 16 is a block diagram of the output module 1230 (FIG. 12), according to an exemplary embodiment. As shown in FIG. 16, the output module 1230 includes a determination unit 1237, a fourth determining unit 1238, and a fourth output unit 1239.

The determination unit 1237 is configured to determine an importance rank of the application among all applications based on the historical use information.

The fourth determining unit 1238 is configured to determine whether the importance rank of the application among all applications determined by the determination unit 1237 is higher than or equal to a preset rank.

The fourth output unit 1239 is configured to output removal prompting information including preset highlighted prompting contents when the fourth determining unit 1238 determines that the importance rank of the application among all applications is higher than or equal to the preset rank.

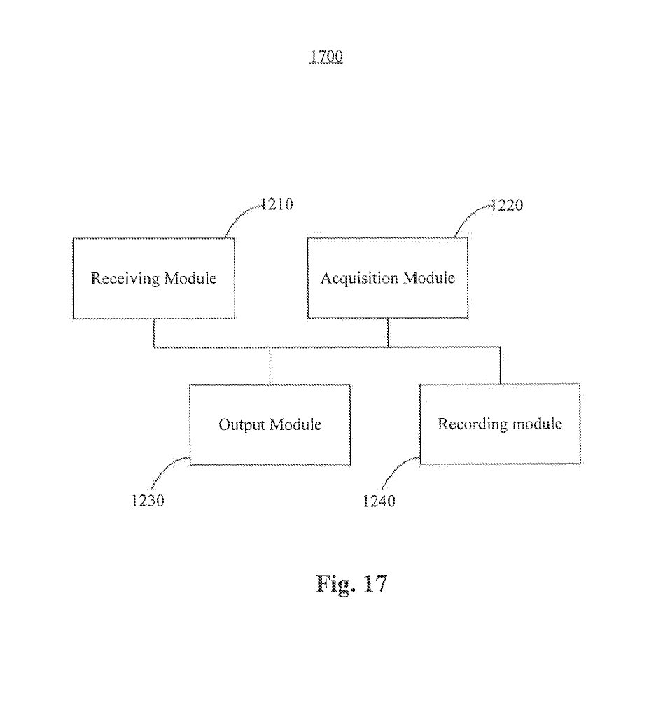

FIG. 17 is a block diagram of a device 1700 for prompting application removal, according to an exemplary embodiment. As shown in FIG. 17, the device 1700 further includes a recording module 1240, in addition to the receiving module 1210, the acquisition module 1220, and the output module 1230 (FIG. 12).

The recording module 1240 is configured to record the historical use information of the application acquired by the acquisition module 1220.

With respect to the devices in the above embodiments, the specific manners for performing operations for individual modules therein have been described in detail in the embodiments regarding the methods for prompting application removal, which will not be elaborated herein.

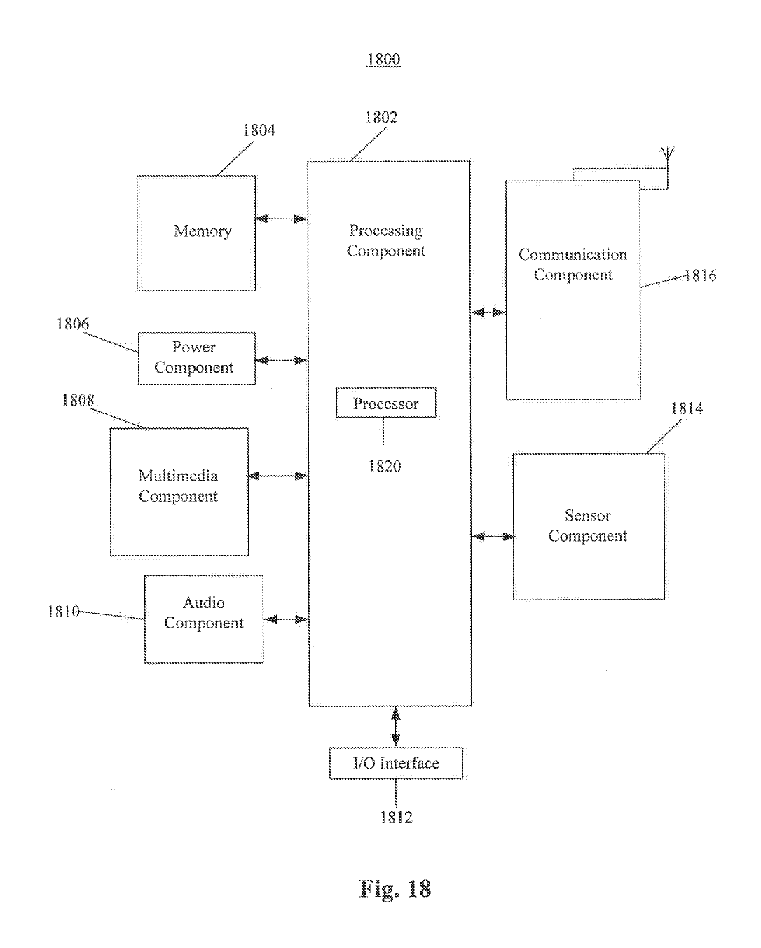

FIG. 18 is a block diagram of a terminal device 1800 for prompting application removal, according to an exemplary embodiment. For example, the terminal device 1800 may be a mobile phone, a computer, a digital broadcast terminal, a messaging device, a gaming console, a tablet, a medical device, exercise equipment, a personal digital assistant, and/or the like.

Referring to FIG. 18, the terminal device 1800 may include one or more of the following components: a processing component 1802, a memory 1804, a power component 1806, a multimedia component 1808, an audio component 1810, an input/output (I/O) interface 1812, a sensor component 1814, and a communication component 1816. The person skilled in the art should appreciate that the structure of the terminal device 1800 as shown in FIG. 18 does not intend to limit the terminal device 1800. The terminal device 1800 may include more or less components or combine some components or other different components.

The processing component 1802 typically controls overall operations of the terminal device 1800, such as the operations associated with display, telephone calls, data communications, camera operations, and recording operations. The processing component 1802 may include one or more processors 1820 to execute instructions to perform all or part of the steps in the above described methods. Moreover, the processing component 1802 may include one or more modules which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the terminal device 1800. Examples of such data include instructions for any applications or methods operated on the terminal device 1800, contact data, phonebook data, messages, pictures, video, etc. The memory 1804 is also configured to store programs and modules. The processing component 1802 performs various functions and data processing by operating programs and modules stored in the memory 1804. The memory 1804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 is configured to provide power to various components of the terminal device 1800. The power component 1806 may include a power management system, one or more power sources, and any other components associated with the generation, management, and distribution of power in the terminal device 1800.

The multimedia component 1808 includes a screen providing an output interface between the terminal device 1800 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures performed on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and/or the rear camera may receive an external multimedia datum while the terminal device 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 include a microphone configured to receive an external audio signal when the terminal device 1800 is in an operation mode, such as a call mode, a recording mode, and/or a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and/or a locking button.

The sensor component 1814 includes one or more sensors to provide status assessments of various aspects of the terminal device 1800. For instance, the sensor component 1814 may detect an on/off status of the terminal device 1800, relative positioning of components, e.g., the display and the keypad, of the terminal device 1800, a change in position of the terminal device 1800 or a component of the terminal device 1800, a presence or absence of user contact with the terminal device 1800, an orientation or an acceleration/deceleration of the terminal device 1800, and/or a change in temperature of the terminal device 1800. The sensor component 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an accelerometer sensor, a gyroscope sensor, a magnetic sensor, a pressure sensor, or a temperature sensor.

The communication component 1816 is configured to facilitate communication, wired or wirelessly, between the terminal device 1800 and other devices. The terminal device 1800 can access a wireless network based on a communication standard, such as WiFi, 2G, or 3Q, or a combination thereof. In one exemplary embodiment, the communication component 1816 receives a broadcast signal or information from an external broadcast management system via a broadcast channel. In one exemplary embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the terminal device 1800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1804, executable by the processor 1820 in the terminal device 800, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described methods, devices, and modules/units can each be implemented through hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It should be understood that the present disclosure is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for a device to prompt application removal, comprising:
receiving an instruction for removing an application;
acquiring historical use information of the application based on the instruction for removing application; and
outputting removal prompting information based on the historical use information.

2. The method of claim 1, wherein the acquiring of the historical use information comprises:
acquiring one or more of: a use parameter of the application, and a volume of data stored locally by the application, wherein the use parameter includes one or more of a use frequency, a number of use, and a duration of use associated with the application.

3. The method of claim 2, further comprising:
determining whether the use parameter is greater than or equal to a preset threshold; and
if it is determined that the use parameter is greater than or equal to the preset threshold, outputting preset highlighted prompting contents.

4. The method of claim 3, wherein the preset highlighted prompting contents are outputted at least twice, and the preset highlighted prompting contents are outputted by using text or voice.

5. The method of claim 3, wherein the outputting of the preset highlighted prompting contents comprises:
outputting the use parameter in the preset highlighted prompting contents.

6. The method of claim 2, further comprising:
determining whether the volume of data stored locally by the application is greater than or equal to a preset data volume; and
if it is determined that the volume of data stored locally by the application is greater than or equal to the preset data volume, outputting preset highlighted prompting contents.

7. The method of claim 6, wherein the preset highlighted prompting contents is outputted at least twice, and the preset highlighted prompting contents are outputted by using text or voice.

8. The method of claim 6, wherein the outputting of the preset highlighted prompting contents comprises:
outputting the volume of data stored locally by the application in the preset highlighted prompting contents.

9. The method of claim 2, further comprising:
determining whether the use parameter is greater than or equal to a preset threshold and whether the data volume is greater than or equal to a preset data volume; and
if it is determined that the use parameter is greater than or equal to the preset threshold, and the data volume is greater than or equal to the preset data volume, outputting preset highlighted prompting contents.

10. The method of claim 9, wherein the outputting of the preset highlighted prompting contents comprises:
outputting the use parameter and the volume of data stored locally by the application in the preset highlighted prompting contents.

11. The method of claim 1, further comprising:
determining an importance rank of the application based on the historical use information;
determining whether the importance rank is higher than or equal to a preset rank; and
if it is determined that the importance rank of the application is higher than or equal to the preset rank, outputting preset highlighted prompting contents.

12. The method of claim 11, wherein the outputting of the preset highlighted prompting contents comprises:
outputting the importance rank of the application in the preset highlighted prompting contents.

13. The method of claim 1, further comprising:
recording the historical use information of the application.

14. A device, comprising:
a processor; and
a memory for storing instructions executable by the processor;
wherein the processor is configured to:
receive an instruction for removing an application;
acquire historical use information of the application based on the instruction for removing application; and
output removal prompting information based on the historical use information.

15. The device of claim 14, wherein the processor is further configured to:
determine whether a use parameter is greater than or equal to a preset threshold; and
output preset highlighted prompting contents if it is determined that the use parameter is greater than or equal to the preset threshold.

16. The device of claim 14, wherein the processor is further configured to:
determine whether a volume of data stored locally by the application is greater than or equal to a preset data volume; and
output preset highlighted prompting contents if it is determined that the volume of data stored locally by the application is greater than or equal to the preset data volume.

17. The device of claim 14, wherein the processor is further configured to:
determine whether a use parameter is greater than or equal to a preset threshold and whether a volume of data stored locally by the application is greater than or equal to a preset data volume; and
output preset highlighted prompting contents if it is determined that the use parameter is greater than or equal to the preset threshold, and the volume of data stored locally by the application is greater than or equal to the preset data volume.

18. The device of claim 14, wherein the processor is further configured to:
determine an importance rank of the application based on the historical use information;
determine whether the importance rank of the application is higher than or equal to a preset rank; and
output preset highlighted prompting contents if it is determined that the importance rank of the application is higher than or equal to the preset rank.

19. The device of claim 14, wherein the processor is further configured to:
record the historical use information of the application.

20. A non-transitory computer-readable storage medium having stored therein instructions that, when executed by a processor in a device, cause the device to perform operations including:
receiving an instruction for removing an application;
acquiring historical use information of the application based on the instruction for removing application; and
outputting removal prompting information based on the historical use information.
